(19) United States
(12) Patent Application Publication
(10) Pub. No.: US 2006/0095153 A1
(43) Pub. Date: May 4, 2006

(54) Wafer carrier transport management method and system thereof

(76) Inventor: Yung Cheng Chang, Tainan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/980,953

(22) Filed: Nov. 4, 2004

(51) Int. Cl. G06F 19/00

(52) U.S. Cl. 700/121

(57) ABSTRACT

A system and method for wafer carrier transport management. The method acquires an identity for a first wafer carrier before receiving a move-out complete (MOC) message for a second wafer carrier, issues a move-in request (MIR) with the identity to a transport system, acquires a destination for the second wafer carrier when an operation complete notification is received from the fabrication tool, and issues a move-out request (MOR) with the destination to the transport system.

### BACKGROUND

The present invention relates to transport management technology, and more particularly, to a method and system of wafer carrier transport management.

A conventional semiconductor factory typically includes requisite fabrication tools to process semiconductor wafers for a particular purpose, employing processes such as photolithography, chemical-mechanical polishing, or chemical vapor deposition. During manufacture, the semiconductor wafer passes through a series of process steps, performed by various fabrication tools. In the production of an integrated semiconductor product, for example, a semiconductor wafer can pass through up to 600 process steps.

The wafers are typically stored in containers, such as cassettes, each of which holds up to 25 wafers. The cassettes are then loaded in carriers, such as standard mechanical interfaces (SMIFs) or front opening unified pods (FOUPs) for transport throughout the factory. A carrier may contain multiple wafer lots to undergo a fabrication task. An automated material handling system (AMHS) is employed to move carriers containing wafer lots from one location to another based on instructions from the MES in a 300 mm fab. Wafer carriers are typically input to the AMHS using automated equipment. Automated equipment is also used to remove wafer carriers using the fabrication tool loadport as the exit point, with the AMHS and/or removal equipment designed to allow several wafer carriers to accumulate near locations while preventing collisions between adjacent wafer carriers. A material control system (MCS) connects to multiple host computers and each host computer connects to multiple fabrication tools. An equipment automation program (EAP) is embedded in the host computer for transferring messages and issuing commands between the MCS and the fabrication tool. The MCS follows a series of standard procedural steps to issue commands to the AMHS, and the AMHS transfers wafer carriers accordingly.

FIG. 1 is a diagram of a wafer lot transport cycle using a conventional method. Typically, the wafer lot transport cycle includes three sequential phases: move-out P1, move-in P2 and processing P3. At the beginning of the move-out phase P1a, the host computer connecting to a fabrication tool sends a move-out request (MOR) message to the MCS to direct the AMHS to remove wafer carriers from the loadport of a fabrication tool. At the end of the move-out phase P1b, the MCS sends a move-out complete (MOC) message to notify the host computer that the transport is complete, and subsequently enters the move-in phase P2. At the beginning of the move-in phase P2a, the host computer sends a move-in request (MIR) message to the MCS to direct the AMHS to move wafer carriers into the loadport of a fabrication tool. At the end of the move-out phase P2b, the MCS sends a move-in complete (MIC) message to notify the host computer that the transport is complete, and subsequently enters the processing phase P3. After one or more operations for the wafers are complete, the process enters the next move-out phase P1 to remove the wafer carriers from the loadport of a fabrication tool. The fabrication tool typically idles for a period of time, such as, more than 10 minutes between the beginning of each move-out phase P1a and the end of each move-in phase P2b, T11, thus, capacity of fabrication tool is reduced. In view of these limitations, a need exists for a system and method of wafer carrier transport management that reduces idle time, thereby increasing fabrication tool capacity.

### SUMMARY

An embodiment of the invention discloses a method for wafer carrier transport management. The method comprises acquiring an identity for a first wafer carrier which will be processed by a fabrication tool before receiving a move-out complete (MOC) message for a second wafer carrier, issuing a move-in request (MIR) with the identity to a transport system to transport the first wafer carrier to the loadport of the fabrication tool, acquiring a destination for the second wafer carrier which has been processed by the fabrication tool when an operation complete notification is received from the fabrication tool, and issuing a move-out request (MOR) with the destination to the transport system to remove the second wafer carrier from the loadport of the fabrication tool and transport the second wafer carrier to the destination. Fabrication of at least one semiconductor device on a wafer in the wafer carrier utilizes the disclosed method.

Preferably, the method further comprises acquiring the remaining operation time for the second wafer carrier, determining whether the remaining operation time for wafer lot in the second wafer carrier is shorter than a predetermined threshold, and acquiring the identity for the first wafer in response when the remaining operation time for the second wafer carrier is shorter than the predetermined threshold.

An embodiment of the invention yet additionally discloses a system for wafer carrier transport management. The system comprises a communication device and a processing unit. The processing unit acquires an identity for a first wafer carrier which will be operated by a fabrication tool before receiving a move-out complete (MOC) message for a second wafer carrier, issues a move-in request (MIR) with the identity to a transport system to transport the first wafer carrier to the loadport of the fabrication tool via the communication device, acquires a destination for the second wafer carrier which have been operated completely by the fabrication tool when an operation complete notification is received from the fabrication tool, and issues a move-out request (MOR) with the destination to the transport system to remove the second wafer carrier from the loadport of the fabrication tool and transport the second wafer carrier to the destination. Preferably, the processing unit further acquires the remaining operation time for wafer lot in the second wafer carrier, determines whether the remaining operation time for the second wafer carrier is shorter than a predetermined threshold, and acquires the identity for the first wafer carrier in response when the remaining operation time for the second wafer carrier is shorter than the predetermined threshold.

The identity for the first wafer carrier may be acquired between the receipt of the operation complete notification and the MOC message for the second wafer carrier. The identity for the first wafer carrier may be acquired when the operation complete notification is received.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a diagram of a wafer lot transport cycle utilizing a conventional method;

FIG. 2 is a diagram of a wafer carrier transport management system applicable to the first and second embodiments of the invention;

FIG. 3 is a diagram of a hardware environment of host computer applicable to the first and second embodiments of the invention;

FIG. 4 is a flowchart illustrating a first method for wafer carrier transport management according to a first embodiment of the invention;

FIG. 5 is a diagram of the wafer transport cycle utilizing a first method;

FIG. 6 is a diagram of a storage medium for a computer program providing a first method of wafer transport management according to a first embodiment of the invention;

FIG. 7 is a flowchart illustrating a second method for wafer carrier transport management according to a second embodiment of the invention;

FIG. 8 is a diagram of the wafer transport cycle utilizing a second method;

FIG. 9 is a diagram of a storage medium for a computer program providing a second method of wafer transport management according to a second embodiment of the invention.

### DESCRIPTION

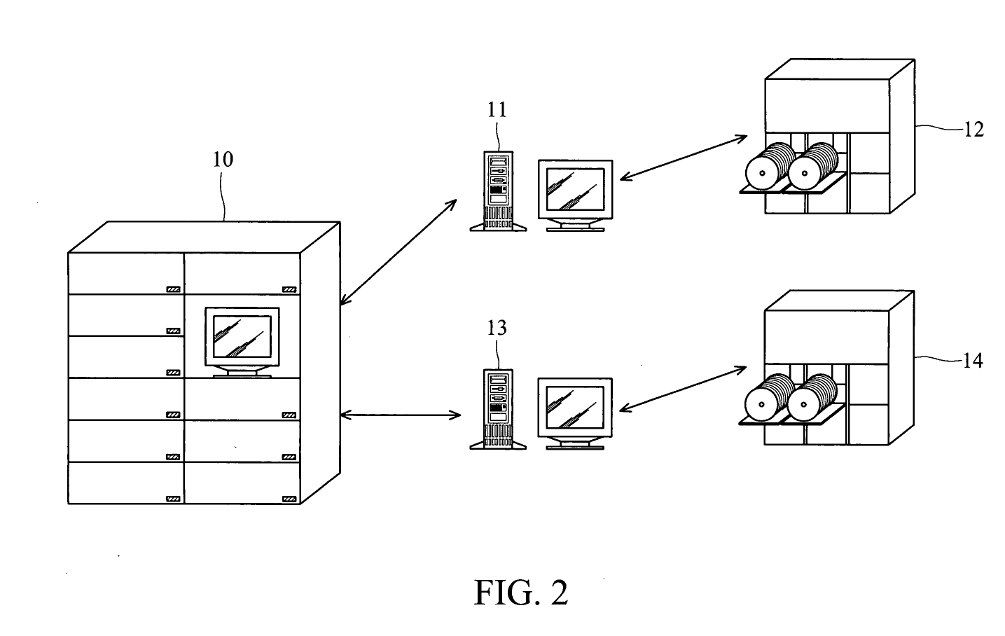

FIG. 2 is a diagram of a wafer carrier transport management system applicable to the first and second embodiments of the invention. According to embodiments of the invention, the system preferably includes a material control system (MCS) 10, host computers 11 and 13, and fabrication tools 12 and 14. The MCS 10 connects to host computers 11 and 13, and each host computer connects to fabrications tool 12 and 14 respectively.

Fabrication tools 12 and 14 typically perform a single wafer fabrication task on the wafers in a given lot. For example, a particular fabrication tool may perform layering, patterning, doping, implanting or heat treatment operations. Fabrication tools 12 and 14 preferably provide software services compliant with 300 mm semiconductor equipment and material international (SEMI) standards specifying transport protocol, message format and functionality. Fabrication tool 12 may be a fixed buffer equipment, in which a loadport bolted onto the exterior of the tool interfaces with an automated material handling system (AMHS) (not shown) to load carriers for processing. Fabrication tool 14 may be an internal buffer equipment, such as diffusion furnace, wet bench, or others, which intake, process and store carriers via a carrier buffer or mini-stocker. When an operation is complete, an operation completion notification, such as “E300:OperationComplete” or others, compliant with the SEMI standard, is issued to the corresponding host computers 11 or 13.

The MCS 10 follows a series of standard procedural steps to issue commands to an automated material handling system (AMHS, not shown), and the AMHS (not shown) transfers wafer carriers accordingly. The AMHS (not shown) is employed to move carriers containing wafers from one location to another based on instructions from the MES in a 300 mm fab. Wafer carriers are typically input to the AMHS (not shown) using automated equipment. Automated equipment is also used to remove wafer carriers using the fabrication tool loadport as the exit point, with the AMHS and/or removal equipment designed to allow several wafer carriers to accumulate near locations while preventing collisions between adjacent wafer carriers. The MCS 10 and the AMHS (not shown) may be incorporated in a transport system.

Equipment automation programs (EAPs) are embedded in the host computers 11 and 13 for transferring messages and issuing commands between the MCS and the fabrication tool. The messages and commands may be transferred via a manufacturing execution system (MES, not shown), and the like with relevant message buses. The MES (not shown) may be an integrated computer system representing the methods and tools used to accomplish production. For example, the primary functions of the MES (not shown) may include collecting wafer processing data in real time, organizing and storing the wafer processing data in a centralized database, work order management, fabrication tool management and process management.

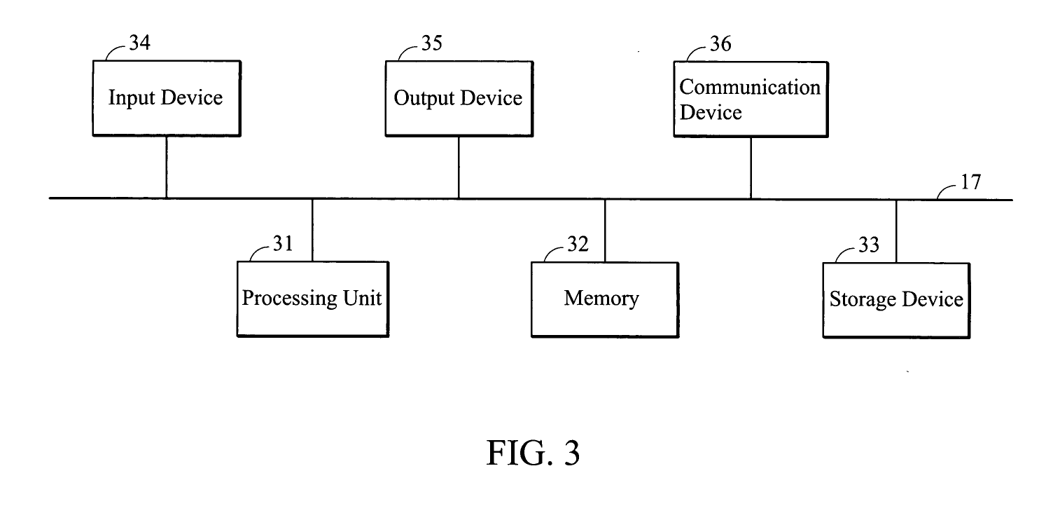

FIG. 3 is a hardware environment of host computer applicable to the first and second embodiments of the invention. The description of FIG. 3 is provides a brief, general description of suitable computer hardware and a suitable computing environment in conjunction with which at least some embodiments may be implemented. The hardware environment of FIG. 3 includes a processing unit 31, a memory 32, a storage device 33, an input device 34, an output device 35 and a communication device 36. The processing unit 31 is connected by buses 37 to the memory 32, storage device 33, input device 34, output device 35 and communication device 36 based on Von Neumann architecture. There may be one or more processing units 31, such that the processor of the computer comprises a single central processing unit (CPU), a micro processing unit (MPU) or multiple processing units, commonly referred to as a parallel processing environment. The memory 32 is preferably a random access memory (RAM), but may also include read-only memory (ROM) or flash ROM. The memory 32 preferably stores program modules executed by the processing unit 31 to perform wafer transport management functions. Generally, program modules include routines, programs, objects, components, or others, that perform particular tasks or implement particular abstract data types. Moreover, those skilled in the art will understand that at least some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web object, Web Services or other similar architectures. The storage device 33 may be a hard drive, magnetic drive, optical drive, a portable drive, or nonvolatile memory drive. The drives and their associated computer-readable media (if required) provide nonvolatile storage of computer-readable instructions, data structures or program modules. The communication device 16 may be an Ethernet drive or a wireless network drive compatible with 802.x or GPRS.

### FIRST EMBODIMENT

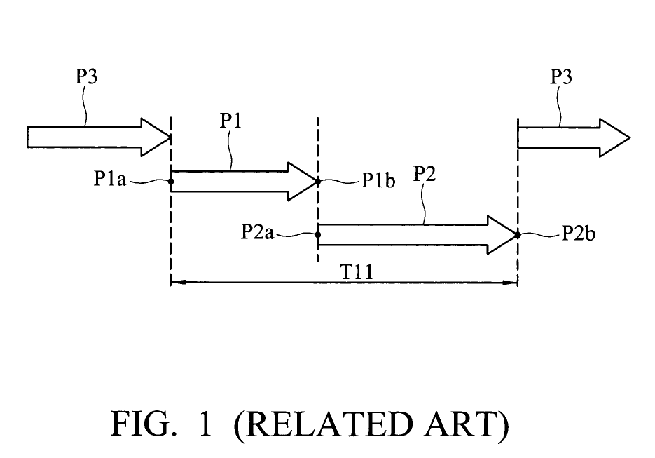

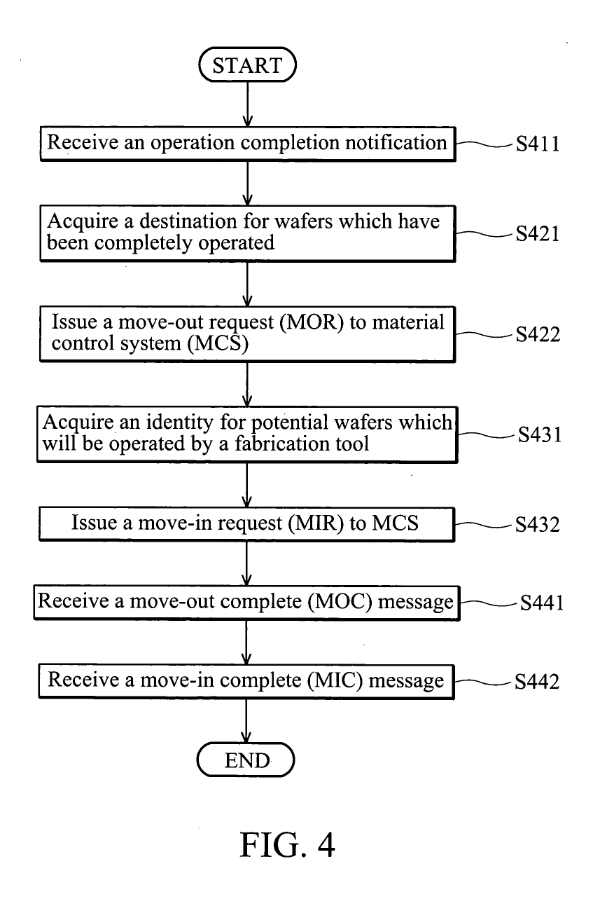

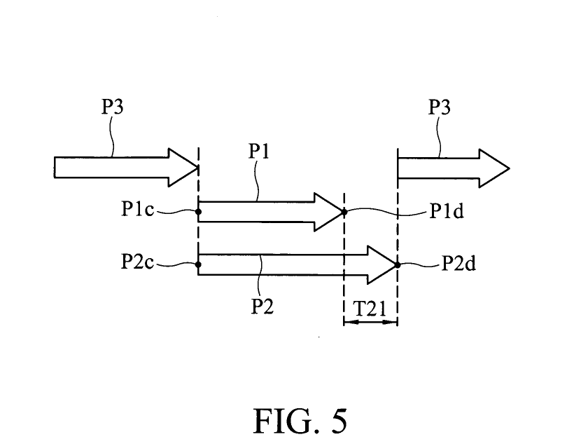

A first embodiment of the invention discloses a first method for wafer carrier transport management, the method is implemented in program modules and executed by the processing unit 31. Fabrication of at least one semiconductor device on a wafer in the wafer carrier utilizes the disclosed first method. FIG. 4 is a flowchart illustrating the method for wafer carrier transport management according to a first embodiment of the invention. The process begins in step S411 by receiving an operation completion notification, such as “E300:OperationComplete” or others, compliant with SEMI standard, from a fabrication tool. In step S421, a destination, such as a fabrication tool, a stocker and the like, for wafers upon which operations are complete, is acquired. The acquisition of the destination may be achieved by querying a MES (not shown) or applying a tool dispatch rule. The tool dispatch rule determines the next destination for specific wafers. The tool dispatch rule may be expressed as meta-rules (rule templates), as the maximum or minimum number of predicates that can occur in the rule antecedent or consequent, or as relationships among attributes, attribute values, and/or aggregates. In step S422, a move-out request (MOR) message with the acquired destination is issued to the MCS 10 via the communication device 36. The MCS 10 follows a series of standard procedural steps to issue commands to an AMHS (not shown), and the AMHS (not shown) removes the wafer carrier from the loadport of fabrication tool accordingly. In step S431, an identity, such as a lot identity, a wafer carrier identity and the like, for potential wafers which will be operated by the fabrication tool, is acquired. The identity acquisition may be achieved by querying a MES (not shown) or applying a lot dispatch rule. The lot dispatch rule determines the next wafer, wafer lot or wafer carrier upon which specific fabrication tool will operate. The lot dispatch rule may be expressed as meta-rules (rule templates), as the maximum or minimum number of predicates that can occur in the rule antecedent or consequent, or as relationships among attributes, attribute values, and/or aggregates. In step S432, a move-in request (MIR) message with the acquired identity is issued to the MCS 10 via the communication device 36. The MCS 10 follows a series of standard procedural steps to issue commands to the AMHS (not shown), and the AMHS (not shown) moves the potential wafer carrier into the loadport of a fabrication tool accordingly. In step S441, a move-out complete (MOC) message indicating the wafer carrier has successfully been removed from the loadport of a fabrication tool, is received via the communication device 36. In step S442, a move-in complete (MIC) message indicating the potential wafer carrier has successfully been moved into the loadport of fabrication tool, is received via the communication device 36. Note that the order of steps S421 to S422 and steps S431 to S432 may be reversed as the transport time for the move-in request may be longer than that for the move-out request. FIG. 5 is a diagram of the wafer transport cycle using a first method. The resulting time waiting for wafer transport is reduced to a period of time between P1d to P2d by employing the disclosed first method. The period of time as shown in T51 of FIG. 5, is much shorter than that as shown in T11 of FIG. 1.

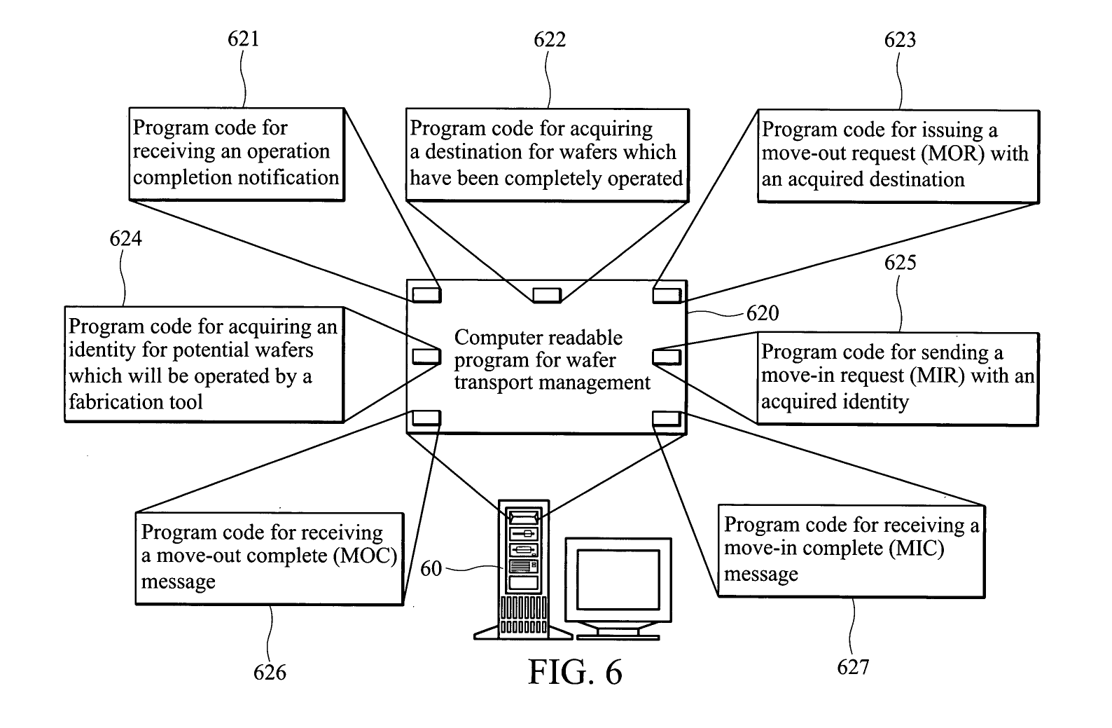

The first embodiment additionally discloses a storage medium storing a computer program providing the disclosed method of wafer carrier transport management, as shown in FIG. 6. The storage medium 60 carries computer readable program code embodied in the medium for use in a computer system, the computer readable program code comprising at least computer readable program code 621 receiving an operation completion notification, computer readable program code 622 acquiring a destination for wafers upon which operations are complete, computer readable program code 623 issuing a MOR with an acquired destination to a MCS, computer readable program code 624 acquiring an identity for potential wafers which will be operated by a fabrication tool, computer readable program code 625 issuing a MIR with an acquired identity to a MCS, computer readable program code 626 receiving a MOC message, and computer readable program code 627 receiving a MIC message.

### SECOND EMBODIMENT

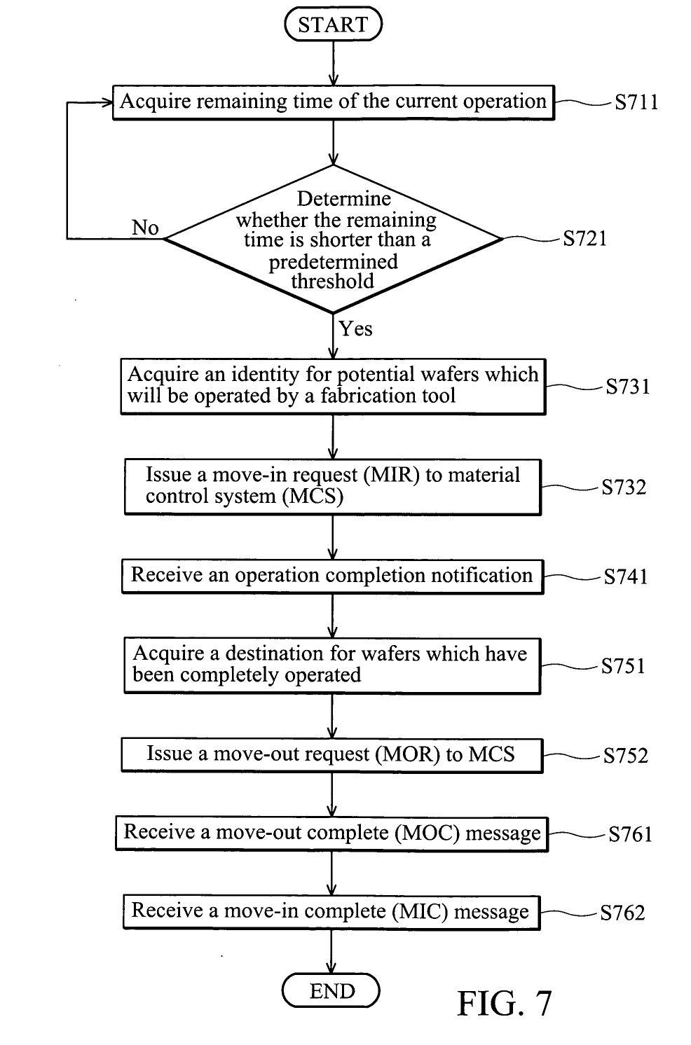

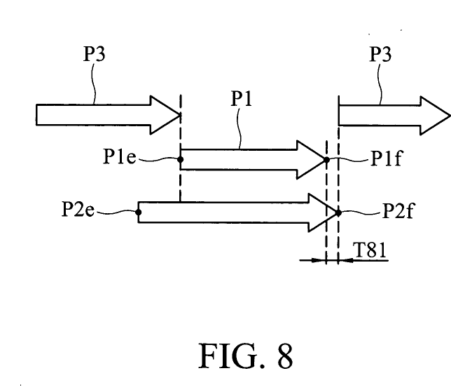

A second embodiment of the invention discloses a second method for wafer carrier transport management, the method is implemented in program modules and executed by the processing unit 31. Fabrication of at least one semiconductor device on a wafer in the wafer carrier utilizes the disclosed second method. FIG. 7 is a flowchart illustrating the method for wafer carrier transport management according to a second embodiment of the invention. The process begins in a periodical detection loop, steps S711 and S721, to detect whether the remaining time of the current operation is shorter than a predetermined threshold. In step S711, the remaining time of the current operation is acquired. The acquisition of the remaining time may be achieved by executing a relevant service compliant with 300 mm SEMI standard of a fabrication tool. In step S721, the process determines whether the remaining time is lower than a predetermined threshold, if so, the process proceeds to step S731, and otherwise, to step S711. The predetermined threshold may be calculated according to an average transport time of move-in requests and an average transport time of move-out requests, and the average transport times may be calculated by numerous historical records in real-time or repeatedly for a period of time. In step S731, an identity, such as a lot identity, a wafer carrier identity and the like, for potential wafers upon which will be operated by a fabrication tool, is acquired. The identity acquisition may be achieved by querying a MES (not shown) or applying a lot dispatch rule. The lot dispatch rule determines what is the next wafer, wafer lot or wafer carrier upon which specific fabrication tool will operate. In step S732, a move-in request (MIR) message with the acquired identity is issued to the MCS 10 via the communication device 16. The MCS 10 follows a series of standard procedural steps to issue commands to the AMHS (not shown), and the AMHS (not shown) moves the potential wafer carrier into the loadport of fabrication tool accordingly. In step S741, an operation completion notification, such as “E300:OperationComplete” or others, compliant with SEMI standard is received from the fabrication tool. In step S751, a destination, such as a fabrication tool, a stocker and the like, for wafers which have been completely operated, is acquired. The acquisition of the destination may be achieved by querying a MES (not shown) or applying a tool dispatch rule. The tool dispatch rule determines the next destination for specific wafers upon which operations are complete. In step S752, a move-out request (MOR) message with the acquired destination is issued to the MCS 10. The MCS 10 follows a series of standard procedural steps to issue commands to an AMHS (not shown), and the AMHS (not shown) removes the wafer carrier from the loadport of the fabrication tool accordingly. In step S761, a move-out complete (MOC) message indicating the operated wafer carrier has successfully been removed from the loadport of the fabrication tool, is received via the communication device 36. In step S442, a move-in complete (MIC) message indicating the potential wafer carrier has successfully been moved into the loadport of the fabrication tool, is received via the communication device 36. FIG. 8 is a diagram of the wafer transport cycle using a second method. The resulting idle time waiting for wafer transport is reduced to between P1f to P2f by employing the disclosed first method. The period of time as shown in T81 of FIG. 8, is the shortest among those shown in T51 of FIG. 5 and T11 of FIG. 1.

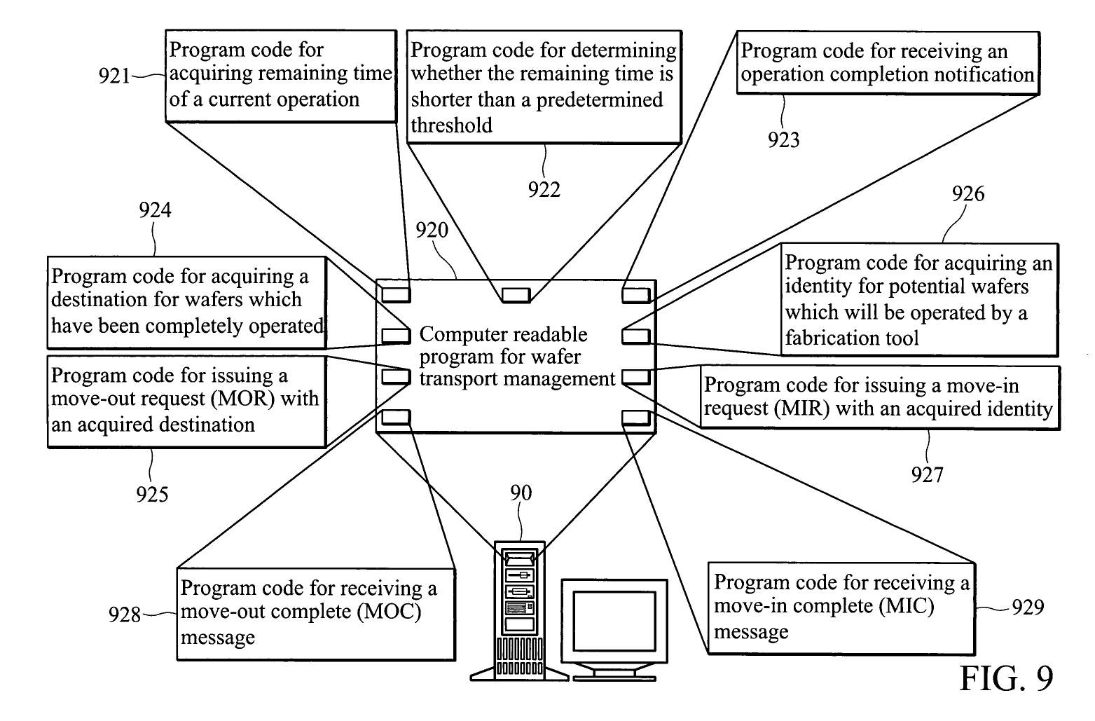

The second embodiment additionally discloses a storage medium storing a computer program providing the disclosed method of wafer carrier transport management, as shown in FIG. 9. The storage medium 90 carries computer readable program code embodied in the medium for use in a computer system, the computer readable program code comprising at least computer readable program code 921 acquiring the remaining time of a current operation, computer readable program code 922 determining whether the remaining time is shorter than a predetermined threshold, computer readable program code 923 receiving an operation completion notification, computer readable program code 924 acquiring a destination for wafers which have been completely operated, computer readable program code 925 issuing a MOR with an acquired destination to a MCS, computer readable program code 926 acquiring an identity for potential wafers which will be operated by a fabrication tool, computer readable program code 927 issuing a MIR with an acquired identity to a MCS, computer readable program code 928 receiving a MOC message, and computer readable program code 929 receiving a MIC message.

Although the disclosed methods are implemented in host computers, the disclosed methods may also be implemented in a MES server, a computer incorporation management (CIM) system server and the like, to direct and control the AMHS.

The embodiments of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for wafer carrier transport management, the method comprising using a processing unit to perform the steps of:
acquiring an identity for a first wafer carrier which will be operated by a fabrication tool before receiving a move-out complete (MOC) message for a second wafer carrier;
issuing a move-in request (MIR) with the identity to a transport system to transport the first wafer carrier to the loadport of the fabrication tool;
acquiring a destination for the second wafer carrier upon which operations by the fabrication tool are complete when an operation complete notification is received from the fabrication tool; and
issuing a move-out request (MOR) with the destination to the transport system to remove the second wafer carrier from the loadport of the fabrication tool and transport the second wafer carrier to the destination.

2. The method of claim 1 wherein the identity for the first wafer carrier is acquired between the receipt of the operation complete notification and the MOC message for the second wafer carrier.

3. The method of claim 1 wherein the identity for the first wafer carrier is acquired when the operation complete notification is received.

4. The method of claim 1 further comprising the steps of:
acquiring the remaining operation time for wafer lot in the second wafer carrier;
determining whether the remaining operation time for wafer lot in the second wafer carrier is shorter than a predetermined threshold; and
acquiring the identity for the first wafer carrier in response to the remaining time of operation for wafer lot in the second wafer carrier is shorter than the predetermined threshold.

5. The method of claim 4 wherein the predetermined threshold is calculated according to an average transport time of move-in requests and an average transport time of move-out requests.

6. The method of claim 1 wherein the identity for the first wafer carrier is acquired by querying a manufacturing execution system or applying a lot dispatch rule.

7. The method of claim 6 wherein the lot dispatch rule determines the next wafer carrier for operation by the fabrication tool.

8. The method of claim 1 wherein the destination for the second wafer carrier is acquired by querying a manufacturing execution system or applying a tool dispatch rule.

9. The method of claim 8 wherein the tool dispatch rule determines the next destination for the second wafer carrier.

10. The method of claim 1 wherein the transport system comprises a material control system (MCS) and an automated material handling system (AMHS).

11. An electronic device made according to the method comprising the steps of:
acquiring an identity for a first wafer carrier which will be operated by a fabrication tool before-receiving a move-out complete (MOC) message for a second wafer carrier;
issuing a move-in request (MIR) with the identity to a transport system to transport the first wafer carrier to the loadport of the fabrication tool;
acquiring a destination for the second wafer carrier upon which operations by the fabrication tool are complete when an operation complete notification is received from the fabrication tool; and
issuing a move-out request (MOR) with the destination to the transport system to remove the second wafer carrier from the loadport of the fabrication tool and transport the second wafer carrier to the destination.

12. A system of wafer transport management, comprising:
a communication device; and
a processing unit coupling to the communication device, configured to acquire an identity for a first wafer carrier which will be operated by a fabrication tool before receiving a move-out complete (MOC) message for a second wafer carrier, issue a move-in request (MIR) with the identity to a transport system to transport the first wafer carrier to the loadport of the fabrication tool via the communication device, acquire a destination for the second wafer carrier upon which operations are complete by the fabrication tool when an operation complete notification is received from the fabrication tool, and issue a move-out request (MOR) with the destination to the transport system to remove the second wafer carrier from the loadport of the fabrication tool and transport the second wafer carrier to the destination.

13. The system of claim 12 wherein the identity for the first wafer carrier is acquired between the receipt of the operation complete notification and the MOC message for the second wafer carrier.

14. The system of claim 12 wherein the identity for the first wafer carrier is acquired when the operation complete notification is received.

15. The system of claim 12 wherein the processing unit further acquires the remaining time of operation for the second wafer carrier, determines whether the remaining time of operation for wafer lot in the second wafer carrier is shorter than a predetermined threshold, and acquires the identity for the first wafer carrier in response when the remaining operation time for wafer lot in the second wafer carrier is shorter than the predetermined threshold.

16. The system of claim 15 wherein the predetermined threshold is calculated according to an average transport time of move-in requests and an average transport time of move-out requests.

17. The system of claim 12 wherein the identity for the first wafer carrier is acquired by querying a manufacturing execution system or applying a lot dispatch rule.

18. The system of claim 17 wherein the lot dispatch rule determines the next wafer carrier for operation by the fabrication tool.

19. The system of claim 12 wherein the destination for the second wafer carrier is acquired by querying a manufacturing execution system or applying a tool dispatch rule.

20. The system of claim 19 wherein the tool dispatch rule determines the next destination for the second wafer carrier.

21. The system of claim 12 wherein the transport system comprises a material control system (MCS) and an automated material handling system (AMHS).
